(19) United States
(12) Patent Application Publication
(10) Pub. No.: US 2016/0143311 A1
(43) Pub. Date: May 26, 2016

(54) FOOD ITEM

(71) Applicant: KRAFT FOODS R&D, INC., Deerfield, IL (US)

(72) Inventors: Jaswinder Singh Dhadda, Mumbai (IN); Richard John Andrews, Birmingham (GB)

(73) Assignee: KRAFT FOODS R&D, INC., Deerfield, IL (US)

(21) Appl. No.: 14/903,473

(22) PCT Filed: Jul. 23, 2014
(86) PCT No.: PCT/IB2014/063330

§ 371 Date: Jan. 7, 2016

(30) Foreign Application Priority Data
Aug. 7, 2013 (GB) 1314109.8

(51) Int. Cl. A23G 1/00; A23G 3/34; B65D 85/60; A23G 7/00; B65B 47/10; B65D 75/04; A23G 1/22; A23G 3/02

(52) U.S. Cl. CPC A23G 1/0086; A23G 1/226; A23G 3/0034; A23G 3/0273; A23G 7/0062; B65B 47/10; B65D 75/04; B65D 85/60

(57) ABSTRACT

In an example embodiment, there is provided a method for producing an at least partially wrapped food item (60), the method comprising: forming a depression in a sheet, the sheet comprising a plastic material (80); dispensing deformable food material into the depression (82); at least partially solidifying the food material to form the food item (84); using the sheet in which the depression is formed as at least part of a wrapper for the food item (86); and in at least one part of the method, providing a rigid support (70) for the depression.

### CROSS-REFERENCE TO RELATED APPLICATIONS

This application is a 371 of International Application No. PCT/IB2014/063330, filed Jul. 23, 2014, which claims priority to Great Britain Application No. 1314109.8, filed Aug. 7, 2013, both of which are hereby incorporated by reference in its entirety.

### FIELD

The disclosure relates to a food item, and a method and apparatus for producing a food item. In one example embodiment, the present invention relates to an at least partially wrapped food item, and a method and apparatus for producing such an at least partially wrapped food item. The food may be confectionery.

### BACKGROUND

Typically, a confectionery item, such as a chocolate bar or similar, is formed in a mould. The item is then removed from the mould, for subsequent wrapping of the item. Wrapping applied to the confectionery item may be made to at least partially conform to a shape of the item, for example for functional or aesthetic packaging reasons. In order to conform the wrapper with respect to the shape of the confectionery item, heat and/or pressure may need to be applied to the wrapping material. The same or similar is true for other food items formed and/or in or using a mould.

A disadvantage of the above process is that the application of heat and/or pressure to the wrapper might have a negative affect on the item itself. For instance, the heat and/or pressure may change a shape, or consistency, or quality, or the like of the item. For instance, heat and/or pressure may change the shape of the item in an undesired manner. Alternatively and/or additionally, the heat may cause at least partial surface melting of one or more parts of the item, which can affect the appearance, consistency, or overall aesthetic quality of the item.

Another disadvantage associated the above process is that the moulding of the item, removal of the item from the mould and subsequent wrapping of the item is not undertaken in a particularly efficient manner. For instance, each of the stages of the process are considered and implemented in isolation, with little or no consideration being given to the overall process and associated efficiencies.

### SUMMARY

It is an aim of an example embodiment to provide an at least partially wrapped food item, apparatus for making such an item, and/or a method for making such an item, that at least partially obviates or mitigates at least of the disadvantages of the prior art, whether identified herein or elsewhere, or to provide an alternative to existing items, apparatus, and/or methods.

As disclosed herein, there is provided an at least partially wrapped food item, apparatus for making an item, and a method for making such an item, as set forth in the independent chains. Other features will be apparent from the dependent claims, and the description which follows.

In an example embodiment, there is provided a method for producing an at least partially wrapped food item comprising: forming a depression in a sheet that comprises a plastic material; dispensing deformable food material into the depression; at least partially solidifying the food material to form the food item; using the sheet in which the depression is formed as at least part of a wrapper for the food item; and in at least one part of the method, providing a rigid support for the depression.

In an example embodiment, there is provided a method for producing an at least partially wrapped food item comprising: forming a depression in a sheet that comprises a plastic material; dispensing deformable food material into the depression; at least partially solidifying the food material to form the food item; using the sheet in which the depression is formed as at least part of a wrapper for the produced food item; and wherein the sheet has a thickness of less than 0.2 mm.

In an example embodiment, there is provided a method for producing an at least partially wrapped food item comprising: forming a depression in a sheet; dispensing deformable food material into the depression; at least partially solidifying the food material to the food item; using the sheet as the entire wrapper for the food item, the wrapper enveloping the food item.

in an example embodiment, there is provided a method for producing an at least partially wrapped food item comprising: forming a depression in a sheet by establishing a vacuum in-between the sheet and a shaper arrangement, the shaper arrangement having a plurality of orifices for use in providing the vacuum; dispensing deformable food material into the depression; at least partially solidifying the food material to form the food item; and using the sheet in which the depression is formed as at least part of a wrapper for the food item. Optionally, in one embodiment, a vacuum in-between the sheet and a shaper arrangement may be maintained or established during one or more of: the dispensing of the deformable food material; the at least partial solidifying of the food material; and/or the wrapping of the food item.

In an example embodiment, there is provided an apparatus for producing an at least partially wrapped food item, the apparatus comprising: a shaper arrangement adapted to form a depression in a sheet that comprises a plastic material; a dispenser arrangement adapted to dispense deformable food material into the depression to at least partially form the food item; a wrapper arrangement adapted to form at least a part of a wrapper of the food item using the sheet in which the depression is formed; and a rigid support for the depression.

In an example embodiment, there is provided an apparatus for producing an at least partially wrapped food item, the apparatus comprising: a sheet dispenser for dispensing a sheet of plastic material, and/or a sheet of material, the sheet comprising a plastic material, and/or the sheet having a thickness of less than 0.2 mm; a shaper arrangement adapted to form a depression in the sheet; a dispenser arrangement adapted to dispense deformable food material into the depression to at least partially form the food item; and a wrapper arrangement adapted to form at least a part of a wrapper of the food item using the sheet in which the depression is formed.

In an example embodiment, there is provided an apparatus for producing an at least partially wrapped food item, the apparatus comprising: a shaper arrangement adapted to form a depression in a sheet; a dispenser arrangement adapted to dispense deformable food material into the depression to at least partially form the food item; and a wrapper arrangement adapted to form an entire wrapper of the food item wrapper envelops the food item, using the sheet in which the depression is formed.

In an example embodiment, there is provided an apparatus for producing an at least partially wrapped food item, the apparatus comprising: a shaper arrangement and a vacuum source, together configured to establish a vacuum in-between a sheet and the shaper arrangement in order to form a depression in the sheet, the shaper arrangement comprising a plurality of orifices for use in establishing the vacuum; a dispenser arrangement adapted to dispense deformable food material into the depression to at least partially form the food item; and a wrapper arrangement adapted to farm at least a part of a wrapper of the food item using the sheet in which the depression is formed. Optionally, in one embodiment, a (e.g. the same or another) vacuum source may be provided, and may be configured to establish or maintain a vacuum between the sheet and the shaper arrangement during one or more of: the dispensing of the deformable food material; the at least partial solidifying of the food material; and/or the wrapping of the food item.

In an example embodiment, there is provided an at east partially wrapped food item, made in accordance with a method comprising: forming a depression in a sheet that comprises a plastic material; dispensing deformable food material into the depression; at least partially solidifying the food material to form the food item; using the sheet in which the depression is formed as at least part of a wrapper for the shaped food item; and in at least one part of the method, providing a rigid support for the shaped depression.

In an example embodiment, there is provided an at least partially wrapped food item, made in accordance with a method comprising: forming a depression in a sheet that comprises a plastic material; dispensing deformable food material into the depression; at least partially solidifying the food material to form the food item; using the sheet in which the depression is formed as at least part of a wrapper for the produced food item; and wherein the sheet has a thickness of less than 0.2 mm.

In an example embodiment, there is provided an at least partially wrapped food item, made in accordance with a method comprising: forming a depression in a sheet; dispensing deformable food material into the depression; at least partially solidifying the food material to form the food item; using the sheet as the entire wrapper for the food item, the wrapper enveloping the food item.

In an example embodiment, there is provided an at least partially wrapped food item, made in accordance with a method comprising: forming a depression in a sheet by establishing a vacuum in-between the sheet and a shaper arrangement, the shaper arrangement having a plurality of orifices for use in establishing the vacuum; dispensing deformable food material into the depression; at least partially solidifying the food mater to form the food item; and using the sheet in which the depression is formed as at least part of a wrapper for the food item. Optionally, in one embodiment, a vacuum in-between the sheet and a shaper arrangement may be maintained or established during one or more of: the dispensing of the deformable food material; the at least partial solidifying of the food material; and/or the wrapping of the food item.

The depression may form a part of a wrapper of the food item.

A rigid support may be provided, providing a rigid support for the depression. The rigid support might be, or function as, the shaper arrangement.

The rigid support may be provided before, during and/or after one or more of: the forming of the depression; the dispensing of the food material; the at least partial solidifying of the food material; and/or the wrapping of the food item.

The method may be undertaken in a continuous manner. That is, one or more of the following may be undertaken on the same continuous sheet: the forming of the depression; the dispensing of the food material; the at least partial solidifying of the food material; and/or at least a part of the wrapping of the food item.

The sheet may have a thickness of less than 0.2 mm.

The sheet may comprise a plastic e.g. polymer based material. The sheet may comprise a different material, and may be, for example, at least partially metallic.

The forming of the depression in the sheet may leave at least a remaining portion of the sheet adjacent to and outside of the depression. That is, a portion of the sheet may not form part of the depression.

The portion of the sheet that does not form part of the depression may be used in the wrapping, of further wrapping, of the food item.

The wrapping may comprise using the sheet as the entire wrapper for the food item.

The wrapper may envelop the food item, and not just extend along or around a portion of the item.

One or more parts of the sheet may be sealed with respect to one another to the wrapper. The seal may be a re-sealable seal.

One or more parts of the depression may be patterned or textured. That is, one or more such parts may not be a completely flat surface.

The rigid support used to support the depression may be shaped to match a pattern or texture of the one or more parts of the depression.

The at least partial solidifying of the food material may comprise cooling of the food material.

The at least partial solidification may be achieved passively, or via active implementation of some kind.

Forming the depression may comprise the use of one or both of: heat; and/or negative or positive pressure. Thermoforming may be used. Vacuum forming may be used.

Negative pressure may be provided in the form a vacuum established between the sheet and the shaper arrangement.

The shaper arrangement may be provided with a plurality of orifices for use in establishing the vacuum.

A vacuum in-between the sheet and the shaper arrangement may be maintained or established during one or more of: the dispensing of the deformable food material; the at least partial solidifying of the food material; and/or the wrapping of the food item.

The shaper arrangement may be or function as the rigid support.

A solidification arrangement may be provided or use, which is adapted to at least partially solidify the food material to form the food item.

The food material may comprise a confectionery material, for example a chocolate-related material.

The method may comprise the at least partial wrapping of a plurality food items.

Features of any example embodiment may, where appropriate, be combined with and/or replace a feature of any other example embodiment, as would be apparent to the skilled person, without departing from the scope of the invention as defined by the claims

### BRIEF DESCRIPTION OF THE FIGURES

For a better understanding of the invention, and to show how example embodiments of the same may be carried into effect, reference will be made, by way of example only, to the accompanying diagrammatic Figures, in which:

FIG. 1 schematically depicts an apparatus for producing an at least partially wrapped confectionery item, in accordance with an example embodiment;

FIG. 2 schematically depicts principles associated with the use of the apparatus of FIG. 1, in accordance with an example embodiment;

FIG. 3 schematically depicts a depression formed in a sheet, in accordance with an example embodiment;

FIGS. 4-6 schematically depict further principles associated with the use of the apparatus of FIG. 1, in accordance with an example embodiment;

FIG. 7 schematically depicts principles associated with the wrapping of a confectionery item, in accordance with an example embodiment;

FIG. 8 schematically depicts principles associated with the use of the apparatus of FIG. 1, in accordance with an example embodiment;

FIG. 9 schematically depicts a confectionery item when removed from its wrapper, in accordance with an example embodiment;

FIGS. 10-13 schematically depict further principles associated with, or related to, the use of the apparatus of FIG. 1, in accordance with an example embodiment;

FIG. 14 schematically depicts a rigid support structure, in accordance an embodiment; and

FIG. 15 schematically depicts a method of producing an at least partially wrapped confectionery item, in accordance with an example embodiment.

### DETAILED DESCRIPTION

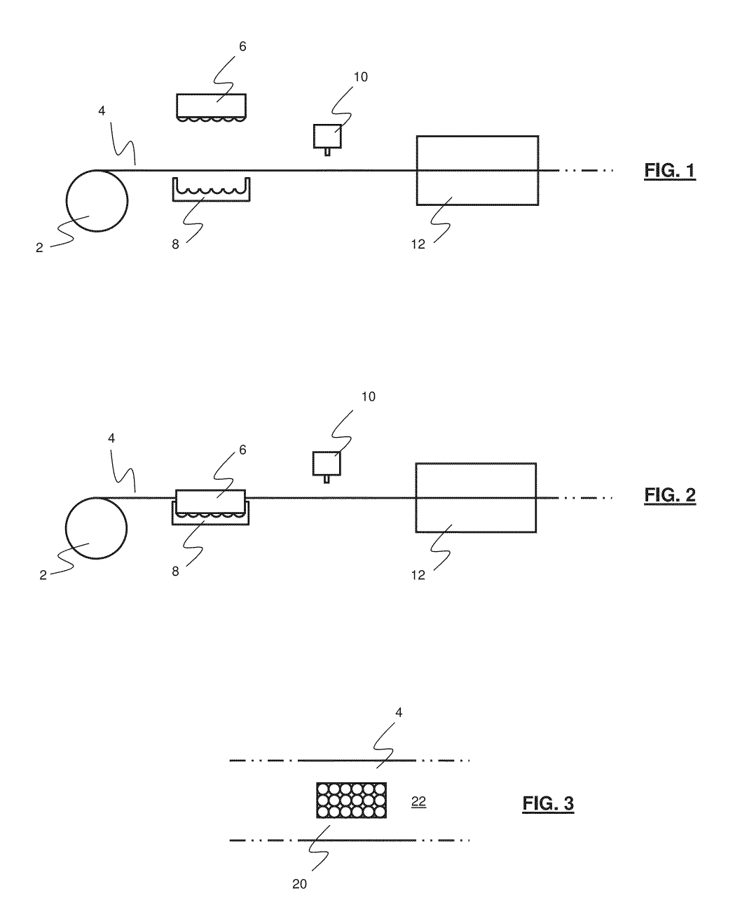

FIG. 1 schematically depicts an apparatus for producing an at least partially wrapped confectionery item, in accordance with an example embodiment. The apparatus comprises a sheet dispenser (2) for dispensing sheet material (4). In this example embodiment, the sheet dispenser (2) comprises a reel of sheet material, but in other example embodiments different arrangements are possible. For example, a stack of separate or connected sheets may be provided. Referring back to FIG. 1, the sheet (4) may comprise a plastic (e.g. polymer based) material. Such a sheet may be more readily manipulated (e.g. conveyed, shaped, sealed and so on) than, for instance, metal foil, or the like. In other example embodiments, a sheet comprising a different material may be used, for example a sheet comprising a metallic material. In one embodiment, the sheet may be less than 0.2 mm in thickness. Such a thickness strikes a balance between providing a sheet which maintains structural integrity during the manipulation of the sheet, but also facilitates manipulation. instance, the sheet may be PA/PEM 30/45 μm, or in another example APET/PE 150/50 μm. The sheet may be substantially 100 μm thick or less. The sheet may be greater than 0.01 mm in thickness. In other embodiments, a sheet having a different thickness may be used, which sheet may be greater than 0.2 mm in thickness. As can be seen in the Figure, the sheet (4) extends through and/or about other components of the apparatus, as will now be described.

The sheet (4) first extends through a shaper arrangement (6, 8) that is adapted to form a depression in the sheet (4). The shaper arrangement (6, 8) may comprise a male part (6) and a female part (8) of a mould. The mate part may be referred to as a stamp.

Further downstream in the apparatus is located a dispenser arrangement (10), adapted to dispense deformable confectionery material into a depression formed in the sheet (4). The dispenser arrangement (10) may comprise, or be in fluid connection with, a reservoir (not shown) of deformable confectionery material. For example, the dispenser arrangement (10) may be in fluid connection with a reservoir of such material via one or more conduits or the like.

In this example embodiment, the deformable confectionery material may be, for instance, confectionery material in at least partially fluid or molten form, and may be, for instance, chocolate-related in nature. A chocolate-related material may be, for instance, chocolate, a material containing chocolate, or a material having a chocolate flavour or flavouring. For instance, the chocolate-related material may be a chocolate-substitute.

Further downstream is located a wrapper arrangement (12), adapted to form at least a part of a wrapper of or for the confectionery item. The wrapper arrangement (12) is adapted to form the wrapper using the same sheet in which the depression is formed. The wrapper arrangement (12) is shown schematically in the Figures as a box, but this is simply for explanatory purposes. In practice, the wrapper arrangement (10) might not be, or comprise, or require a box or box-like housing, and could instead take any appropriate form necessary to perform the required wrapping.

Although not shown in the Figures, one or more further elements may be present in the apparatus. For instance, solidification of the confectionery material will be required at some stage during the production of the confectionery item. The solidification may be undertaken passively, by cooling and/or setting in the ambient temperature in which the apparatus is used. The ambient temperature may be refrigerated. Alternatively and/or additionally, one or more dedicated arrangements may be located in, or locatable in, the apparatus for faciiating more active cooling. The solidification may be undertaken by appropriate changes in temperature, which is perhaps the most common way of solidifying a confectionery item. However, solidification might also be undertaken chemically or the like, for example by adding one or more components to a confectionery material which results in solidification of that material. The solidification arrangement may thus take the form of a refrigeration element or chamber, or a cooling plate or similar. In another embodiment, the arrangement may dispense cooling fluid into or onto the confectionery item, and for example comprise fluid blowers, or cool fluid blowers, or similar. The fluid could be air, or nitrogen in liquid or gas form. It is most likely that any such solidification arrangement that is located in a particular location of the apparatus, as opposed to simply reducing the ambient temperature of the entire apparatus, will be located in (e.g. as part of) or after (e.g. downstream of) the dispenser arrangement (10), which dispenses deformable (e.g. fluid or molten) confectionery material.

One or more other further elements may be provided, and not shown in the Figures. For example, although not shown in the Figure, the apparatus is, in practice, likely to additionally comprise one or more conveyors, or rollers, or similar, for moving the sheet (4) through the apparatus.

In FIG. 1 it can be seen that each element of the apparatus is shown in a stationary configuration. However, it will be appreciated that, in use, or in one or more different example embodiments, the elements may be movable, or changeable in shape. For instance, it will be appreciated that the sheet dispenser (2) may move in order to dispense amount of sheet (4). The sheet (4) itself will move through the apparatus or parts of the apparatus. One or more parts of the dispenser arrangement (6, 8) may move toward and, subsequently, away from the sheet (4) to form a depression in that sheet (4). One or more parts of the dispenser arrangement (10) may move, for example towards and/or away from the sheet (4), in order to dispense material in a depression formed in that sheet (4). As already alluded to above, the wrapper arrangement (12) may also move, or one or more components of that wrapper arrangement (12) may move, in order to apply at least partial wrapping to the confectionery item. For example, one or more guides, arms, or the like may be used to fold or otherwise manipulate the sheet (4) in the wrapping of the confectionery item, and/or to seal different parts of the sheet relative to one another to wrap the item.

The apparatus may be used in a continuous manner. That is, one or more of the following may be undertaken on the same continuous sheet: the forming of the depression; the dispensing of the confectionery material; the solidifying of the confectionery material; and/or at least a part of the wrapping of the confectionery item.

A more detailed explanation of the operation of the apparatus will now be described, by way of example only, with reference to FIGS. 2 to 15.

FIG. 2 shows the male part (6) of the mould being moved into the female part (8) of the mould, with a portion of the sheet (4) trapped in-between. The application of pressure and/or heat at the same time as, or as a consequence of, such movement causes a depression to be formed in the sheet (4). For instance, the depression may be formed using thermoforming or the like.

FIG. 3 shows a plan view of the sheet (4), having the depression (20) formed in the sheet (4). It can also be seen that a portion (22) of the same sheet (4) remains adjacent to and at least partially surrounding the depression (20). As described further below, this portion (22) may be used in wrapping of a confectionery item, or what might more accurately be described as further wrapping the confectionery item.

It can be seen in FIGS. 1 to 3 that the depression formed in the sheet is, in at least this embodiment, not simply cuboid in nature, but is more shaped than this. In this embodiment, the depression comprises a plurality of adjacent hemispheres. In general, the depression may be ‘more’ shaped in that it is patterned or textured in nature, insofar as there is at least one surface that is not flat. For instance, the patterned or textured surface may take the form of a lip, a relief, a contour, a complex shape, a text, or an image in relief, and so on.

In order to form the depression in the sheet (4), movement of the sheet (4) through the apparatus may be stopped while the depression (20) is being formed. Alternatively, the speed of the sheet (4) may be reduced while the depression (20) is being formed, or the depression (20) may be formed quickly enough for movement of the sheet (4) to remain unchanged. In another example, the feeding of the sheet (4) to the shaper arrangement (6, 8) may be such that there is some slack in the feed. The slack may allow for the sheet (4) at the shaper arrangement (6, 8) to be stationary, whilst the sheet (4) before and after the shaper arrangement may be moving. In another example, the shaper arrangement (6, 8) may move with the sheet (4) to maintain movement of the sheet (4) through the apparatus.

FIG. 4 shows that the depression (20) has been formed in the sheet Additionally, the sheet (4) has been moved along through the apparatus, to position the depression (20) in a location to receive deformable confectionery material from the dispenser arrangement (10). In this embodiment, the depression (20) is located beneath an outlet of the dispenser arrangement (10).

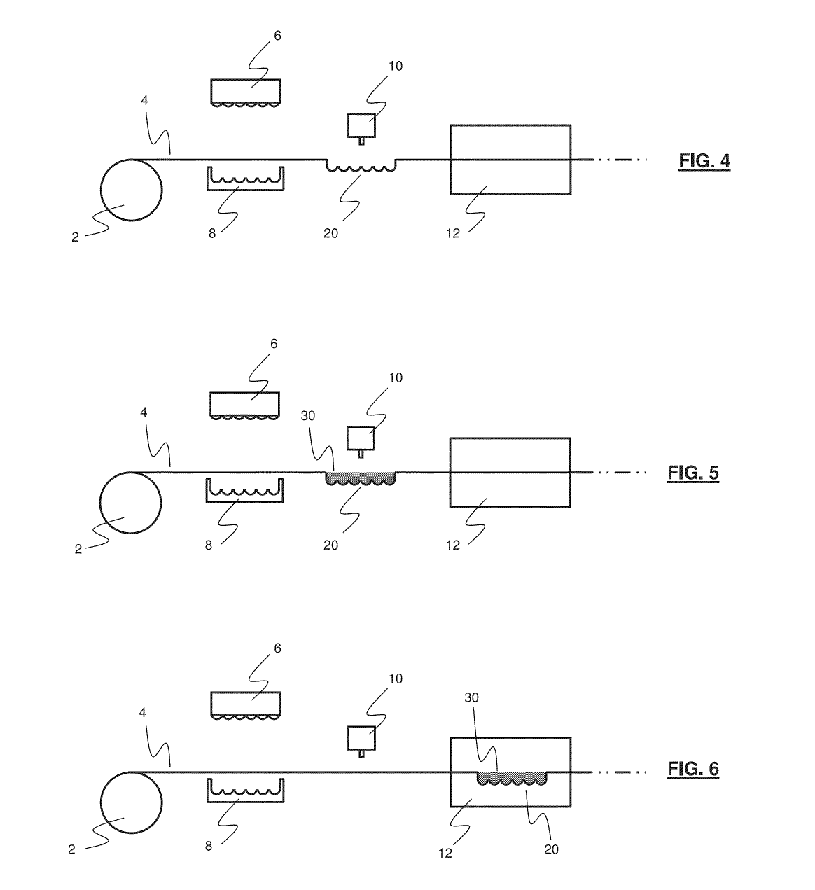

FIG. 5 shows the depression (20) in the sheet after the depression (20) has been filled with deformable confectionery material (30) from the dispenser arrangement (10). It can readily be seen that, due to the deformable nature of the confectionery material (30), the confectionery material takes the form of the depression (20) in the sheet (4). Although not shown, a stencil and/or scraper may be used to ensure that the material (30) is accurately applied into the depression (20), and to a required level within or relative to, the depression (20).

Although not shown, the confectionery material (30) may then be vibrated, to level the material (30) and/or to remove any bubbles trapped in the material. A vibrator arrangement may come into contact with the depression (20), or a support holding or in contract with the depression (20). In another embodiment, such a support may be the vibrator arrangement.

The confectionery material (30) in the depression (20) is then solidified to form a finished confectionery item (30), either by solidification within the temperature of the ambient environment, or by more localised action. Such action might include, for example, the use of one or more cooling elements, or the blowing of air or the like onto the sheet (4) and/or confectionery material (30), or by adding material to the confectionery material (30) to trigger or promote solidification.

FIG. 6 shows the situation when the sheet and the (now filled) depression (20) are, together, moved further downstream in the apparatus to the wrapper arrangement (12). The wrapper arrangement (12) at least partially wraps the confectionery item. The depression (20) in the sheet (4), which was used to shape at least a portion of the confectionery material, is also used to form at least part of this wrapper. In one example embodiment, an entire wrapper of the confectionery item, which envelops the confectionery item, is formed from the same sheet (4) in which the depression (20) is formed, as will now be described.

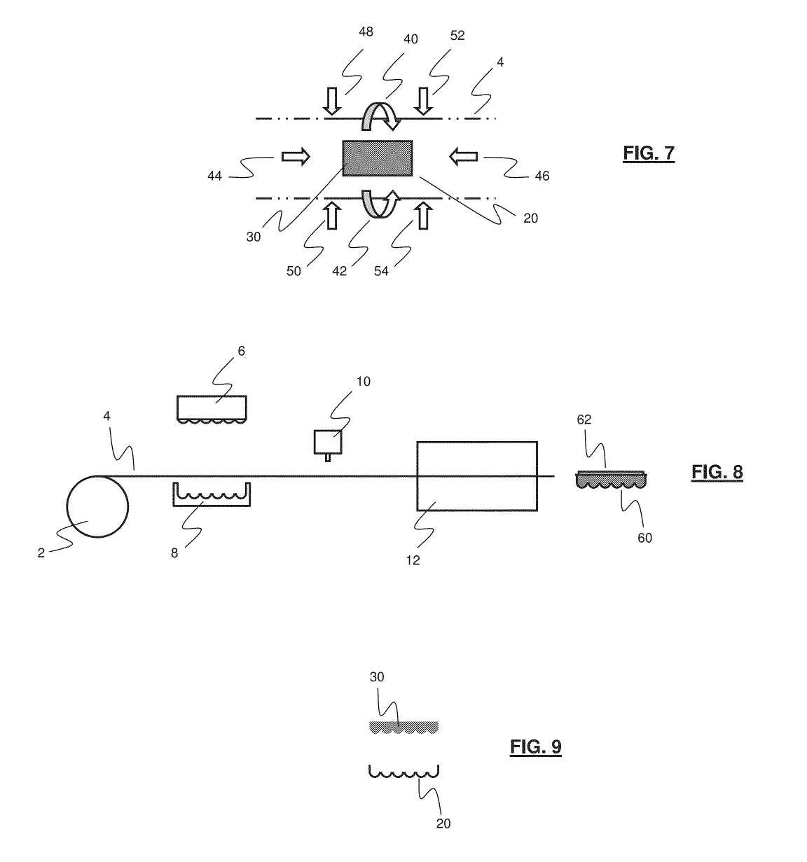

FIG. 7 shows an example embodiment of how wrapping might take place. The sheet (4) is shown in plan view, as is the depression (20) that is filled with confectionery material (30). The sheet portion (22) in which no depression was formed, and which surrounds the depression (20), is also shown. It is this portion (22) which is used to further wrap around one or more sides of the confectionery material that are not in contact with the depression (20), thus allowing a wrapper portion, and in one example embodiment an entire wrapper, to be formed. For instance, the portion (22) may be wrapped around a hack and/or one or more sides of the material (30).

A number of arrows are shown in FIG. 7. These emphasise wrapping, perforating, sealing and/or cutting actions, and will now be described in more detail. One of more guides, arms, or similar of the wrapper arrangement may be used to wrap portions of the sheet (22) not forming the depression (20) around a hack-side or reverse of the confectionery item (30), as indicated by arrows (40, 42)—i.e. a back-side of the confectionery item (30) opposite to that a major side or face, for example that in contact with a patterned or textured area of the depression (20). After such wrapping, opposite sides of the sheet (4) that have been wrapped around the item (30) are sealed with respect to one another to form a wrapper that extends around the confectionery item. The sealing is indicated by arrows (44, 46). The seal may be permanent in nature, or may be, for instance, re-sealable, allowing the eventually wrapped confectionery item to be conveniently selectively opened and closed by a consumer. One or more sealing and/or cutting and/or perforating actions may then be taken across the sheet (4) as indicated by arrows (48, 50, 52, 54) to finalise the wrapping of the confectionery item (30), and/or to separate the wrapped item from upstream or downstream sheet (4), or to facilitate such separation. A finally produced and wrapped confectionery item is thus provided.

In FIG. 7, cuts, seals or similar upstream and downstream of that item (30) are shown and described. If the process for producing the item is continuous, as shown in the preceding Figures, the downstream cut and seal (or similar) may be undertaken as part of an upstream cut and seal of a confectionery item already having been wrapped, or being wrapped, further downstream.

In another embodiment (not shown), the wrapper may be formed using more than one sheet. For example, the sheet depression may form one part of the wrapper, and another sheet completes the wrapper. For example, another sheet may be overlaid on a back or reverse-side of the item (i.e. an opposite side to that shaped by the depression), and sealed with respect to the sheet depression to form the wrapper. In another embodiment (not shown), the sheet depression may be used to form part of the wrapper, and the item and sheet depression may be wrapped in an enveloping wrapper. In another embodiment, an at least partially wrapped item, or more than one of such items, may be later wrapped in further wrapper, for example a pack wrapper (i.e. a wrapper containing a plurality of individually wrapped items).

FIG. 8 shows the apparatus and the final, wrapped confectionery item (60). It can be seen that the sealing of the parts of the wrapper have resulted in a fin-seal extending across the wrapped item (60), which may facilitate easier opening of the item (60), or opening and closing of the item (60) if the seal is re-sealable.

FIG. 9 shows that if and when the confectionery item (30) is removed from the depression (20), the depression (20) and the confectionery item (30) still have co-operating shapes. This shows that the confectionery item (30) has indeed taken and maintained the same (or, more accurately, negative) shape of the depression (20), and also that the depression (20) maintains that shape even when the confectionery item has been removed. All of these features may be advantageous for functional and/or aesthetic reasons, for example tightly wrapping of the item to assist with packing and transport, or to show off the shape the item within the wrapper. When wrapped, or placed in the wrapper, the depression supports the shape of the confectionery item. This may be useful even when the wrapped item has been produced, for example if the confectionery item at least partially melts during transit or storage. The shaped wrapper may maintain the shape of the item when the item eventually solidifies. Additionally, and/or alternatively, the depression always takes the form of the confectionery item, which, as mentioned above, again shows off the shape of the confectionery item to a consumer. The wrapper and item thus support the shape of each another. Any one or more of these features demonstrate that it may be possible to detect from the wrapped item (60), or part thereof (e.g. the wrapper or item within) that the wrapped item (60) was made using a method or apparatus according to an example embodiment.

In accordance with an example embodiment, for instance that described above, the overall process for producing the confectionery item is continuous and, as a result, more efficient. There is no separate forming of the confectionery item in mould, removal that mould, and subsequent wrapping. The whole process is undertaken in a more continuous, and holistic manner. All parts of the method are implemented using the same continuous sheet. This may save on equipment costs, and production costs and/or time. Space required for apparatus used in the production of the item may also be reduced. Using the mould (i.e. depression in the sheet) as at least part of the wrapping material, or described in another way, using at least part of the wrapping material as the mould, also has the advantages described above. For instance, the process as a whole is more efficient. This is particularly true when the sheet in which the depression is formed is used to form the entire wrapper of the confectionery item.

As already briefly described above, one or more parts of the apparatus may be movable. FIG. 10 shows that, in an example embodiment, a rigid support (70) may be provided, for providing a rigid support for the depression formed in the sheet (4). In one instance, this rigid support (70) may be the female part of the mould described previously, or a structural equivalent to that female part of the mould. Generally, then, the rigid support (70) may be a part of the shaper arrangement described previously. Since the rigid support (70) is moveable as indicated by arrow (72), the support (70) may thus be moveable to provide support for the sheet or depression formed in that sheet before, during and/or after the forming of the depression, the dispensing of the confectionery material in the depression, the solidifying of the confectionery material, and/or the wrapping of the confectionery item. More than one rigid support may be provided, for example for use in providing support at different stages of production of a give confectionery item, and/or for providing support for different confectionery items during their production.

FIG. 11 shows the rigid support (70) being used to support the depression (20) in the sheet (4) prior to (and possibly during—see below) the dispensing part of the production method. This might promote the deformable confectionery material accurately adopting the shape of the depression, and keeping that shape. Alternatively, and/or additionally, the rigid support may assist in the depression (20) adopting and maintaining the shape of the support (70), for example if and when the depression (20) cools after being formed using heat.

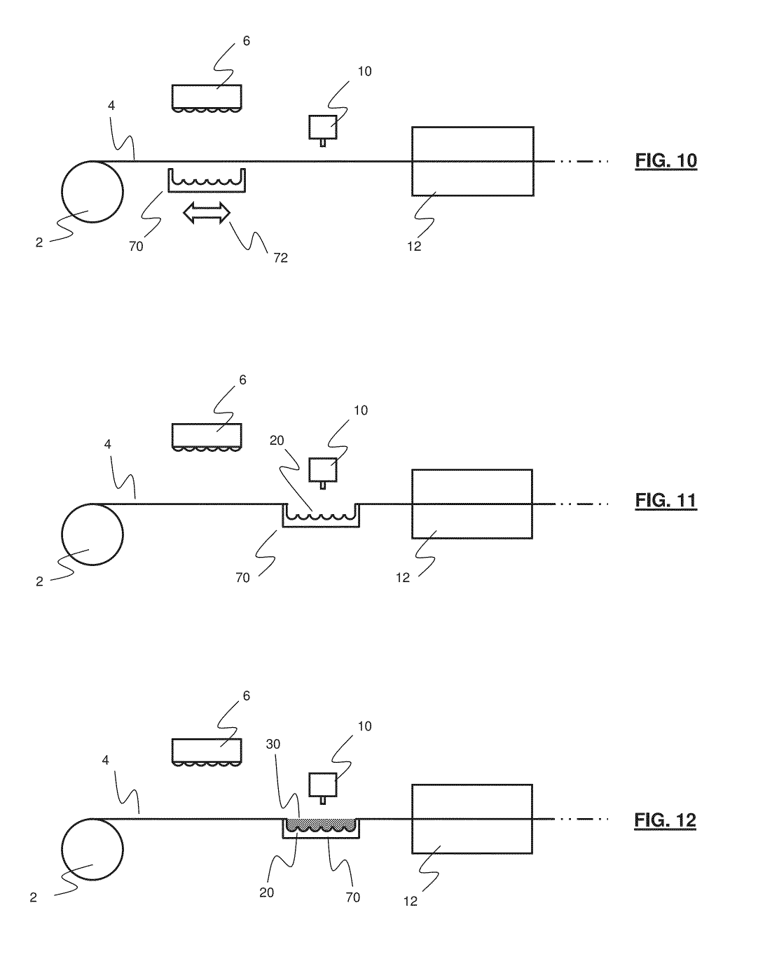

FIG. 12 shows the rigid support (70) in place during (and possibly after) confectionery material (30) has been dispensed into the depression (20). This may provide support to the depression (20) and/or confectionery material (30) to ensure that the shapes of both are maintained, as already discussed above. Alternatively and/or additionally, the support may be maintained during a solidification of the confectionery material (30), again, in order to ensure that the confectionery material (30) satisfactorily adopts and keeps the shape of the depression (20).

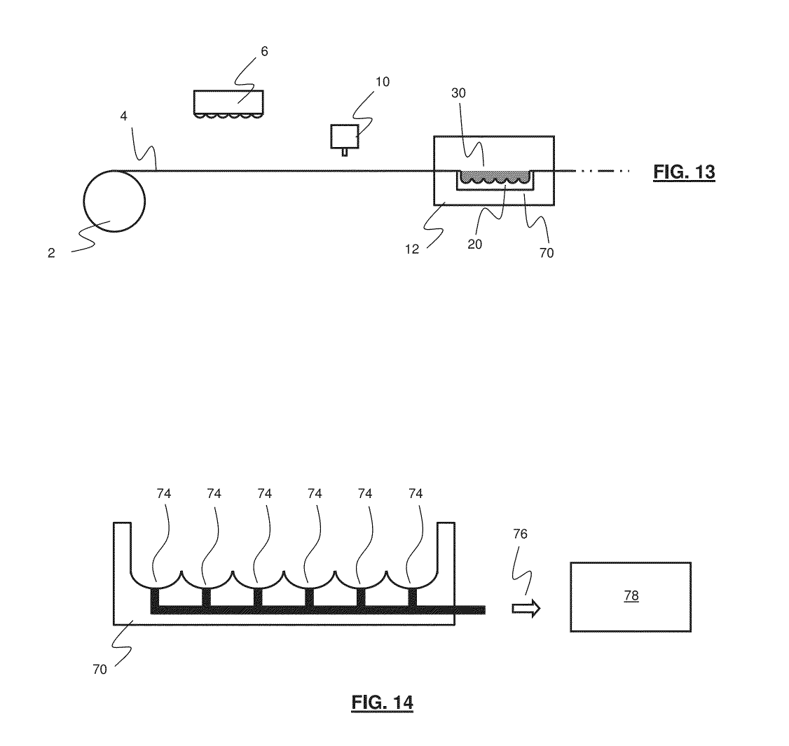

FIG. 13 shows the rigid support (70) providing support during the wrapping part of the method, which may help to prevent damage or the like to the confectionery item (30) or sheet depression (20). Alternatively, use of the support (70) may be a convenient way of holding the item (30) during the wrapping.

In order to facilitate all of the above, the rigid support may not simply be a flat surface or the like, but may instead be shaped to match a pattern or a texture of (i.e. a shaping of) the depression, thus promoting or adopting the shaping of the confectionery item relative to the depression, and/or the maintaining of the shape of the depression during the filling, solidifying and wrapping stages. Thus, the rigid support might alternatively and/or additionally be described as, and in some embodiments be, a part of the shaper arrangement.

In the above embodiments, the pressure and heat has been described as being used to form the depression in the sheet. The pressure so far described has been positive in nature, provided in the form of a stamp or male mould that is pushed into the sheet. In another example, negative pressure (i.e. a vacuum) may be used, alternatively and/or additionally, to the depression. Such negative pressure may have other applications. FIG. 14 is used to depict the use of negative pressure.

In FIG. 14, a more detailed view of an exemplary rigid support (70) is shown. In this example, the rigid support (70) is part of, or simply is, the shaper arrangement, and for instance forms a mould used in the formation of the sheet depression. In this more detailed view, it can be seen that a plurality of orifices (74) are provided in the rigid support (70). As indicated by arrow (76), the orifices (74) are connected to a vacuum source (78). The vacuum source (78) could be attached to or form a part of the rigid support (70), or be in connection with the rigid support (70) via one or more tubes or conduits or the like. The vacuum source may comprise a pump. The orifices (74) may alternatively and/or additionally be referred to as channels, bores, conduits, slits, holes, passageways, and so on. The orifices (74) could have any cross-sectional shape.

The rigid support (70) and vacuum source (78) of FIG. 14 may be used to form a depression in a sheet. In use, a vacuum is established in-between the sheet and the rigid support (70) to draw the sheet into conformity with, and take the shape of, the rigid support (70). Heat may be applied to the sheet, to make the sheet more readily deformable by the application of the vacuum. Positive pressure may also be supplied, for example using a male mould or stamp, as already described above. The use of a vacuum may result in the sheet more readily and accurately adapting the shape of the rigid support (70), in comparison with the use of positively applied pressure. This may be particularly relevant in sections of the rigid support where shaping (e.g. texturing or patterning) is particular fine or complex.

The use of multiple orifices (74) may result in the sheet more readily, and perhaps more quickly, adapting the shape of the rigid support (70), in comparison with the use of only a single orifice. This may be particularly relevant in sections of the rigid support where shaping (e.g. texturing or patterning) is particular fine or complex. In such sections, a spatial density of orifices may be higher than in other sections. In other embodiments, a single orifice may be sufficient, for example to just hold the sheet in place.

The/a vacuum may be maintained or established during one or more of: the dispensing of the deformable confectionery material; the solidifying of the confectionery material; and/or the wrapping of the confectionery item. This may result in the sheet depression keeping the shape of the support during these processes, and in turn result in the confectionery keeping the same shape as that of the depression and support. This may also facilitate heat transfer, which may assist in cooling of the depression after it has been formed in a heated section of sheet, and/or in the solidification of the confectionery material. Also, the use of a vacuum may at least be a convenient approach to retaining the sheet in the rigid support during different stages of the production of the item.

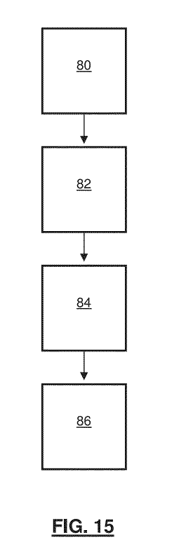

FIG. 15 schematically depicts a general method for producing an at least partially wrapped confectionery item, according to an example embodiment. Initially, a depression is formed in a sheet (80). Next, deformable confectionery material is dispensed into the depression (82). Subsequently, the confectionery material is solidified in the depression (84) to form the confectionery item, the confectionery item matching the shape of the depression (84). Finally, the sheet in which the depression is formed is used to at least partially wrap the confectionery item (86). For instance, the depression may form part of the wrapper.

The wrapping procedure may in some way delineate the wrapper of one item from a wrapper of a previous or subsequent item. This may involve a cut or the like.

The cut may separate the wrappers. Alternatively, this could involve one or more perforations or the like between different wrappers, such that the wrappers are attached to one another, but in a readily separable manner.

It has been described how the thickness of the sheet material may be less than 0.2 mm. In some example embodiments, the thickness of the material may be greater than this. However, in some example embodiments the material is indeed less than 0.2 mm in thickness. For instance, the material may be less than 0.1 mm in thickness. The thinner the material is, the greater the cost saving may be in sheet material. However, thinner material might require more support during the production of the confectionery item, to maintain the shape of the sheet depression and/or confectionery item/material. Thus, for thinner sheet material, the rigid support described above may be even more useful. The material (in terms of its composition or thickness) may be such that the depression formed in the sheet is self-supporting, such that the shape of the depression is maintained even when no external support is provided.

As described above, a single confectionery item is shown as being produced. However, in another embodiment, multiple confectionery items can be made at the same time, in a continuous manner. For instance, when a previously filled depression is being wrapped to form a wrapped item, an upstream depression may be filled. At the same time, an upstream part of the sheet may be provided with a depression for subsequent filling.

The example embodiments described so far have been described as continuous, in that different parts of the production method may be undertaken on the same continuous sheet. However, in another embodiment (not shown), the production might still be continuous, but carried out on sheet sections that are separate from one another. For example, in the above embodiments, the continuous sheet is described as being cut at the wrapping stage. However, the cutting could be undertaken earlier in the process, for example before, during or after the depression is formed in the sheet. In this way, it may be easier to handle and manipulate sheet sections that one continuous sheet.

A confectionery item might be alternatively and/or additionally be described or defined as a food item such as a snack food item. The item may be sweetened artificially and/or naturally. Confectionery items include: chocolate products, including chocolate in bar form, and chocolates; sugar-confectionery or sugar-replacement or candy products, for example caramel products, toffee products, fudge products, marshmallow products, nougat products, sweets and gums; iced confectionery produces, such as ice-cream; and flour confectionery products, for example cakes, biscuits, cookies and sweet pastries. The confectionery item may be a chocolate-related product or a caramel, toffee or fudge product. The confectionery item may be a chocolate or chocolate-based item such as a chocolate bar, for instance a solid chocolate bar or a filled chocolate bar or item. Typically, a confectionery item is formed from a mass of deformable material that is located in a mould, for example a mass of batter, dough, or at least partially molten chocolate or similar. The item is then removed from the mould as a solid product for subsequent wrapping of the item, or is wrapped in and/or using that mould. The confectionery item may have a solid outer surface at ambient temperature. Although an interior of the product may not necessarily be solid, such confectionery items may be self supporting as a result of their solid exterior.

As already alluded to previously, the material could be material other than confectionery material, and the item could be an item other than a confectionery item. For instance, the material may be more broadly described or defined as food material, and the item as a food item. ‘Food’ in this instance may be synonymous with ‘edible’, and may be edible by human or other living species. In one example, the food may be confectionery, as described above, or may be savoury in nature.

Deformable food material may be in liquid or fluid form, or at least be partially malleable and therefore mouldable. The deformable material may be at least partially solidified so as to be in an at least partially rigid, and/or whole, and/or conjoined form by the use of heat, for example cooking or baking, or by the use of cooling, for example chilling or freezing, or by using an additive. The sheet in which the depression is formed will be at least partially resistant or resilient to the cooling, heating and or additive that is required for such solidification. In another example, the material may become more solid once dispensed, for example over a period of time, and/or over a period of time in the atmosphere in which the material is dispensed. To become at least partially solidified, which might be described, alternatively and/or additionally as being more solid, the material might become more viscous, harder, experience a decrease in fluidity, and so on. Such at least partial solidification may take place, at least partially, before, during or after the item is wrapped.

The food material may be of a single type, for example chocolate. The food material and/or its structure or composition may be or comprise different types, for example chocolate, caramel, aeration, inclusions such as nuts etc. The material may be provided in one-shot (i.e. one deposition), or in multiple depositions. This might allow different materials/ingredients to be deposited in different ways, locations or times, for example to allow for layer formation, or hollow or filled shell forms.

A single has been shown in being wrapped. However, a plurality of items may be at least partial lipped. For instance, the overall depression may be divided into different regions, sections, compartments, or the like, so that the dispensing of material into the depression and/or divisions thereof results in the formation of a plurality of bodies of food material, which may eventually form a plurality of wrapped items. The division could be achieved by forming a plurality of adjacent depressions using one or more shaper arrangements. The items may be wrapped together in a single compartment using an overall wrapper as described above. Alternatively, or one of more of such items may be wrapped separately, by appropriate manipulation of such an overall wrapper. For instance, the overall wrapper may be sealed and cut along and/or around the one or more items to be wrapped together.

The use of pressure to form the depression without the use of heat may be referred to as cold-stamping. In a related example, heat does not need to be applied when a vacuum or negative pressure is used to form the depression. In another example, the weight of the deposited material may serve, at least partially, as the pressure used to at least partially form the depression. In one example, the depression may be at least partially formed using a stamp or vacuum, and the deposition of material may complete the formation of the depression.

Although a few exemplary embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing example embodiment(s). The invention extends to any novel one, or any novel combination, of the features disclosed in this specification (including any accompanying claims, abstract and drawings), or to any novel one, or any novel combination, of the steps of any method or process so disclosed.

1. A method for producing an at least partially wrapped food item (60) comprising:
forming a depression in a sheet, the sheet comprising a plastic material (80);
dispensing deformable food material into the depression (82);
at least partially solidifying the food material to form the food item (84);
using the sheet in which the depression is formed as at least part of a wrapper for the food item (86); and
in at least one part of the method, providing a rigid support (70) for the depression.

2. The method of claim 1, wherein the rigid support is provided before, during and/or after one or more of:
the forming of the depression;
the dispensing of the food material;
the at least partial solidifying of the food material; and/or the wrapping of the food item.

3. The method of claim 1, wherein one or more of the following is undertaken on the same continuous sheet:
the forming of the depression;
the dispensing of the food material;
the at least partial solidifying of the food material; and/or
at least a part of the wrapping of the food item.

4. The method of claim 1, wherein the sheet has a thickness of less than 0.2 mm.

5. The method of claim 1, wherein the forming of the depression in the sheet leaves at least a remaining portion of the sheet adjacent to and outside of the depression

6. The method of claim 5, wherein the portion of the sheet is used in the wrapping or further wrapping of the food item.

7. The method of claim 1, wherein the wrapping comprises using the sheet as the entire wrapper for the food item, the wrapper enveloping the food item.

8. The method of claim 1, wherein one or more parts of the sheet are sealed with respect to one another to form the wrapper.

9. The method of claim 8, wherein the seal is a re-sealable seal.

10. The method of claim 1, wherein the depression is patterned or textured.

11. The method of claim 1, wherein the rigid support is shaped to match a pattern or texture of the depression.

12. The method of claim 1, wherein the at least partial solidifying of the food material comprises cooling of the food material.

13. The method of claim 1, wherein forming the depression comprises the use of one or both of: heat; and/or pressure.

14. The method of claim 13, where negative pressure is provided in the form a vacuum established between the sheet and the shaper arrangement.

15. The method of claim 14, wherein the shaper arrangement is provided with a plurality of orifices for use in establishing the vacuum.

16. The method of claim 1, wherein a vacuum in-between the sheet and the shaper arrangement is maintained or established during one or more of: the dispensing of the deformable food material; the at least partial solidifying of the food material; and/or the wrapping of the food item.

17. The method of claim 1, wherein the food material comprises a confectionery material.

18. The method of claim 1, wherein the method comprises producing a plurality of at least partially wrapped food items.

19. A method for producing an at least partially wrapped food item comprising:
forming a depression in a sheet, the sheet comprising a plastic material;
dispensing deformable food material into the depression;
at least partially solidifying the food material to form the food item;
using the sheet in which the depression is formed as at least part of a wrapper for the produced food item; and
wherein the sheet has a thickness of less than 0.2 mm.

20. A method for producing an at least partially wrapped food item comprising:
forming a depression in a sheet;
dispensing deformable food material into the depression;
at least partially solidifying the food material to form the food item;
using the sheet as the entire wrapper for the food item, the wrapper enveloping the food item.

21. A method for producing an at least partially wrapped food item comprising:
forming a depression in a sheet by establishing a vacuum in-between the sheet and a shaper arrangement, the shaper arrangement having at least one orifice for use in providing the vacuum;
dispensing deformable food material into the depression;
at least partially solidifying the food material to form the food item; and
using the sheet in which the depression is formed as at least part of a wrapper for the food item;
a vacuum in-between the sheet and a shaper arrangement being maintained or established during one or more of: the dispensing of the deformable food material; the solidifying of the food material; and/or the wrapping of the food item.

22. An apparatus for producing an at least partially wrapped food item, the apparatus comprising:
a shaper arrangement adapted to form a depression in a sheet, the sheet comprising a plastic material;
a dispenser arrangement adapted to dispense deformable food material into the depression to at least partially form the food item;
a wrapper arrangement adapted to form at least a part of a wrapper of the food item using the sheet in which the depression is formed; and
a rigid support for the depression.

23. An apparatus for producing an at least partially wrapped food item, the apparatus comprising:
a sheet comprising a plastic material, the sheet having a thickness of less than 0.2 mm;
a shaper arrangement adapted to form a depression in the sheet;
a dispenser arrangement adapted to dispense deformable food material into the depression to at least partially form the food item; and
a wrapper arrangement adapted to form at least a part of a wrapper of the food item using the sheet in which the depression is formed.

24. An apparatus for producing an at least partially wrapped food item, the apparatus comprising:
a shaper arrangement adapted to form a depression in a sheet;
a dispenser arrangement adapted to dispense deformable food material into the depression to at least partially form the food item; and
a wrapper arrangement adapted to form an entire wrapper of the food item, which wrapper envelops the food item, using the sheet in which the depression is formed.

25. An apparatus for producing an at least partially wrapped food item, the apparatus comprising:
a shaper arrangement and a vacuum source, together configured to establish a vacuum in-between a sheet and the shaper arrangement in order to form a depression in the sheet, the shaper arrangement comprising a plurality of orifices for use in establishing the vacuum;
a dispenser arrangement adapted to dispense deformable food material into the depression to at least partially form the food item;
a wrapper arrangement adapted to form at least a part of a wrapper of the food item using the sheet in which the depression is formed; and
a vacuum source that is configured to establish or maintain a vacuum between the sheet and the shaper arrangement during one or more of: the dispensing of the deformable food material; the at least partial solidifying of the food material; and/or the wrapping of the food item.

26. An at least partially wrapped food item, made in accordance with a method comprising:
forming a depression in a sheet, the sheet comprising a plastic material;
dispensing deformable food material into the depression;
at least partially solidifying the food material to form the food item;
using the sheet in which the depression is formed as at least part of a wrapper for the shaped food item; and
in at least one part of the method, providing a rigid support for the shaped depression.

27. An at least partially wrapped food item, made in accordance with a method comprising:
forming a depression in a sheet that comprises a plastic material;
dispensing deformable food material into the depression;
at least partially solidifying the food material to form the food item;
using the sheet in which the depression is formed as at least part of a wrapper for the produced food item; and
wherein the sheet has a thickness of less than 0.2 mm.

28. An at least partially wrapped food item, made in accordance with a method comprising:
forming a depression in a sheet;
dispensing deformable food material into the depression;
at least partially solidifying the food material to form the food item;
using the sheet as the entire wrapper for the food item, the wrapper enveloping the food item (86).

29. An at least partially wrapped food item, made in accordance with a method comprising:
forming a depression in a sheet by establishing a vacuum in-between the sheet and a shaper arrangement, the shaper arrangement having a plurality of orifices for use in establishing the vacuum;
dispensing deformable food material into the depression;
at least partially solidifying the food material to form the food item;
using the sheet in which the depression is formed as at least part of a wrapper for the food item;
a vacuum being maintained or established during one or more of: the dispensing of the deformable food material; the at least partial solidifying of the food material; and/or the wrapping of the food item.

30. A method, an apparatus or an at least partially wrapped food item, substantially as herein described, substantially as herein described with reference to the accompanying Figures, or substantially as shown in the accompanying Figures.
